(19) United States
(12) Patent Application Publication
(10) Pub. No.: US 2021/0129636 A1
(43) Pub. Date: May 6, 2021

(54) DOOR OF RECREATIONAL VEHICLES

(71) Applicant: LCI Italy s.r.l., Florence (IT)

(72) Inventor: Simone MONTI, Castelfiorentino (IT)

(21) Appl. No.: 17/082,619

(22) Filed: Oct. 28, 2020

(30) Foreign Application Priority Data
Nov. 5, 2019 (IT) 102019000020342

(51) Int. Cl. B60J 5/04; B60P 3/32

(52) U.S. Cl. CPC B60J 5/049; B60J 5/0447; B60J 5/0444; B60J 5/0483; B60P 3/32; B60J 5/0452

(57) ABSTRACT

A door of recreational vehicles includes a first peripheral frame, a first outer panel, shaped to match the first peripheral frame and positioned inside the first peripheral frame, with the first outer panel extending according to a predetermined plane (P), and a second inner covering panel substantially superposed on the first outer panel.

### CROSS-REFERENCES TO RELATED APPLICATIONS

This application claims priority of Italian Patent Application No. 102019000020342 filed Nov. 5, 2019, the entire contents of which are hereby incorporated by reference in this application.

### DESCRIPTION

This invention relates to a door of recreational vehicles, such as camper vans or caravans. More specifically, the invention relates to a door of recreational vehicles of the reinforced type.

The doors of recreational vehicles, such as camper vans or caravans, must simultaneously guarantee good thermal insulation, a certain degree of lightness and also a minimum of resistance both to burglary and accidental openings.

In order to sufficiently satisfy all these requirements, a door architecture has been widespread for some time comprising a metal frame and one or more panels made of plastic material.

Normally, the metal frame constituting the load-bearing element extends as a peripheral edge of the door and is pivoted on a corresponding counter-frame designed to be stably connected to the wall in which is formed the opening which the door is designed to close. The frame then supports one or more panels which define the inner and outer faces of the door.

The use of at least two panels is now widespread: an outer one substantially flat and integrating both an outer resistant face and a filling of thermally insulating material, and an inner covering, normally made of rigid plastic material, made by moulding and shaped, for example, to also form compartments to hold objects or to surround any window made in the door.

Whilst in many cases the doors described above have been found to be substantially satisfactory, there are also circumstances in which, on the other hand, they do not comply with the safety specifications requested by the manufacturers and/or by the appropriate authorities.

For example, with reference to camper vans, there are situations in which particular sealing characteristics are not required for the door whilst, according to some regulations, the doors must withstand even quite considerable forces.

Normally, this greater resistance is required in those countries in which it is possible to travel freely on board in the living area of the campervan without the requirement to remain seated whilst travelling and fastened with special safety belts.

It therefore occurs quite frequently that doors which are not specially designed to comply with strict safety regulations in the sector of recreational vehicles do not comply with these regulations since they do not withstand the stresses with which they are tested.

In order to increase the strength of these doors, stiffening elements are therefore added which are often not even sufficient to guarantee the required strength but nevertheless have the obvious drawback of increasing the weight of the door considerably.

The aim of the invention is to provide a door of recreational vehicles which allows the above-mentioned problems to be overcome, and is at the same time strong and of limited weight.

A further aim of the invention is to provide a door of recreational vehicles which is simple and inexpensive to make.

The above-mentioned aims are achieved by a door of recreational vehicles comprising the technical features described in one or more of the appended claims.

Further features and advantages of the invention are more apparent in the detailed description which follows, with reference to the accompanying drawings which illustrate a non-limiting example embodiment of the invention and in which:

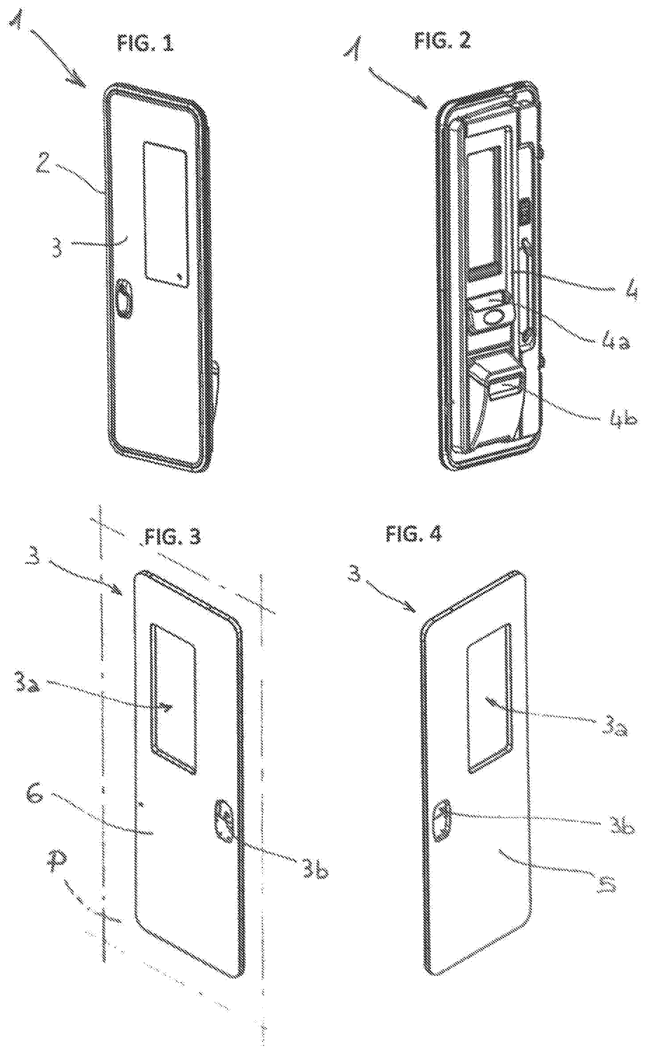

FIG. 1 is a schematic perspective view of a door of recreational vehicles made according to the invention;

FIG. 2 is a schematic perspective view from a different angle of the door of FIG. 1;

FIG. 3 is a schematic perspective view of a detail of a door of the previous drawings;

FIG. 4 is a schematic perspective view from a different angle of the detail of FIG. 3;

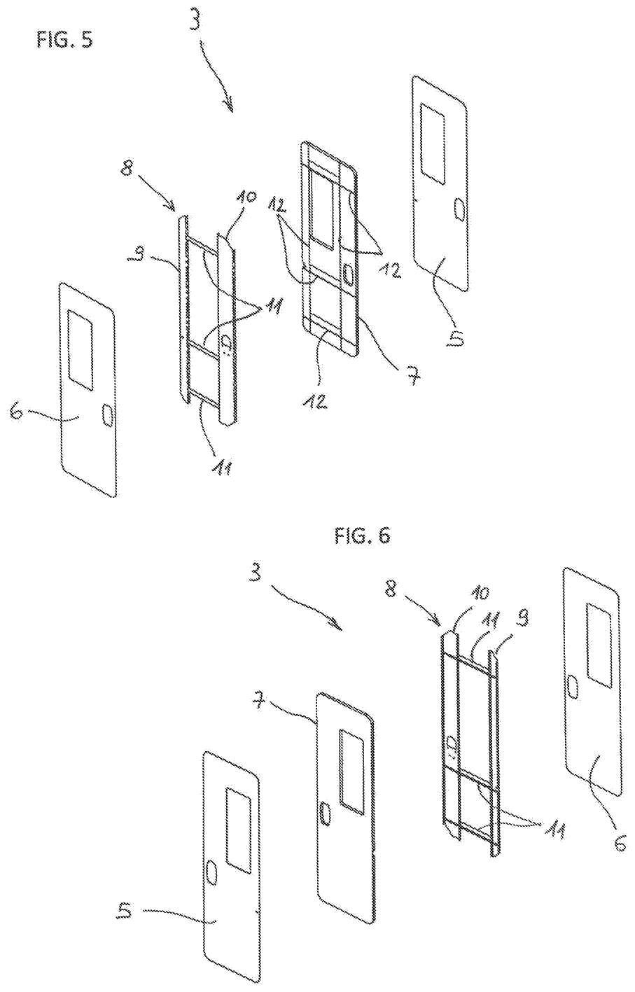

FIG. 5 is an exploded schematic view of the detail of FIG. 3;

FIG. 6 is an exploded schematic view of the detail of FIG. 4;

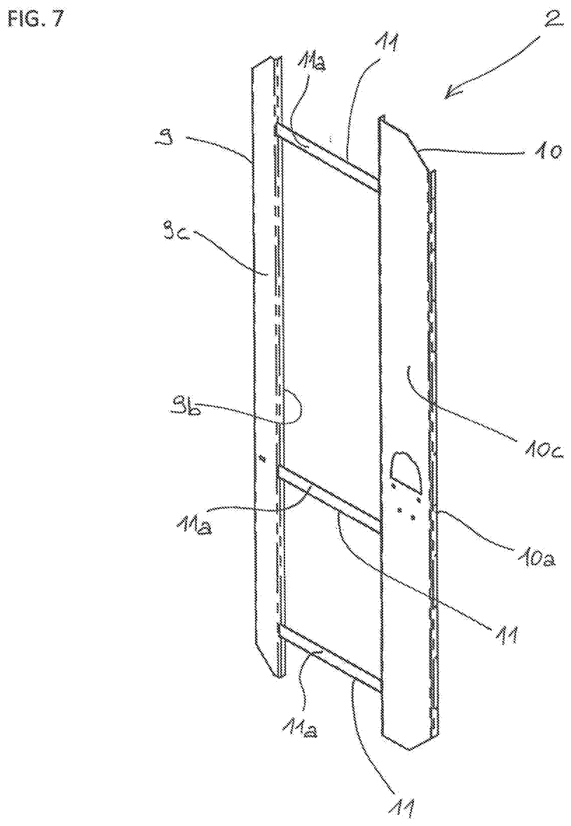

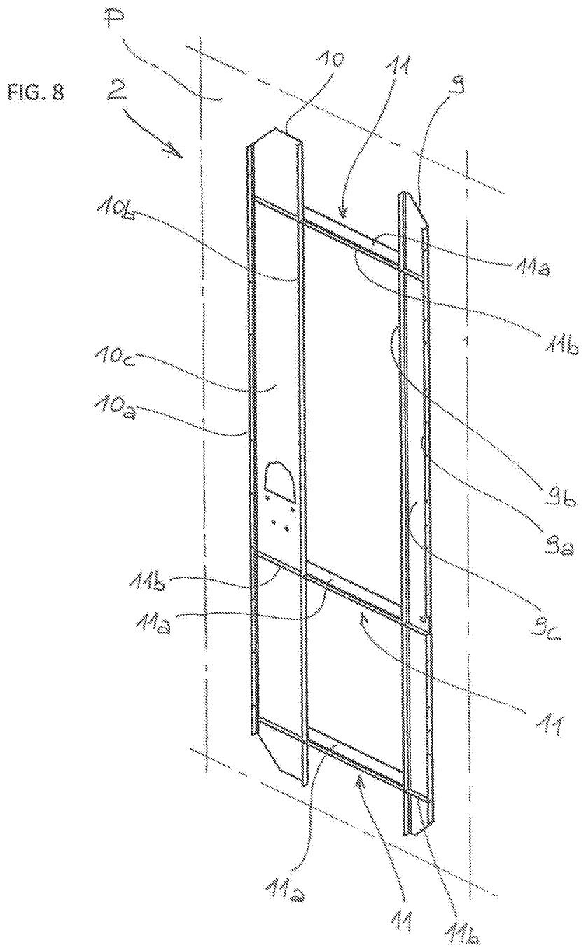

FIGS. 7 and 8 are schematic perspective views from different angles of an element of the detail of FIGS. 3 to 6.

With reference to the accompanying drawings, the numeral 1 denotes in its entirety a door of recreational vehicles made in accordance with the invention and hereinafter denoted for brevity also merely as a door 1.

As illustrated in FIG. 1, the door 1 comprises a first peripheral frame 2 and a first outer panel 3 shaped to match the first peripheral frame 2 and positioned inside it.

The peripheral frame 2 has a quadrangular shape with rounded corners.

The metallic material from which the peripheral frame 2 is made is advantageously aluminium.

According to possible variant embodiments, the metallic material from which the frame 2 is made is steel.

Advantageously, a counter-frame, not illustrated, is hinged to the peripheral frame 2, designed to be fixed to a wall, which is also not illustrated, of the recreational vehicle.

With reference to FIG. 2, the door 1 comprises a second inner covering panel 4 positioned on the side opposite the above-mentioned first outer panel 3 and substantially superposed on the latter.

The second inner covering panel 4 defines an internal lining for the door 1 and is normally made of rigid plastic material.

More in detail, as shown in FIG. 2, according to the preferred but not exclusive embodiment illustrated therein, the second inner covering panel 4 has compartments 4a, 4b to hold objects.

The first outer panel 3 is shown, extrapolated from the rest of the components of the door 1, in FIGS. 3 and 4.

The first outer panel 3 extends according to a predetermined plane P of extension of the door 1, schematically illustrated in FIG. 3 and also FIG. 8.

The first outer panel 3 has two through openings 3a, 3b designed to house, respectively, a window, not illustrated, and the mechanism for opening/closing the door 1, which is also not illustrated.

As illustrated in FIGS. 5 and 6, which shows an exploded configuration, the first outer panel 3 comprises a rigid outer wall 5, an inner covering wall 6 and a filling layer 7 interposed between the above-mentioned rigid outer 5 and inner 6 covering walls.

As illustrated in FIGS. 5 and 6, the door 1 comprises a second internal frame 8 designed to be stably connected to the above-mentioned first peripheral frame 2 to give the door 1 a high degree of rigidity and strength.

With reference to what is illustrated in detail in FIGS. 7 and 8, the second internal frame 8 comprises two vertical lateral pillars 9, 10 and three horizontal crossbeams 11 for connection between the pillars 9, 10.

The horizontal crossbeams 11 are advantageously distributed suitably spaced along the longitudinal extension of the lateral pillars 9, 10.

According to alternative embodiments of the invention, not illustrated, the horizontal crossbeams 11 differ in number to three.

Advantageously, both the lateral pillars 9, 10 and the horizontal crossbeams 11 are made of sheet metal.

The two lateral pillars 9, 10 have a respective edge 9a, 10a for connecting to the above-mentioned first peripheral frame 2.

The connecting edges 9a, 10a are advantageously made by bending the metal sheet. According to the preferred embodiment illustrated in FIGS. 7 and 8, each of the two lateral pillars 9, 10 has a U-shaped transversal cross-section with a flat central portion 9c, 10c positioned parallel to the above-mentioned predetermined plane P and two respective opposite lateral portions 9a, 9b and 10a, 10b, at right angles to the predetermined plane P. The lateral portions 9a, 10a define, for each lateral pillar 9, 10 the above-mentioned respective connecting edge to the first peripheral frame 2.

Again with reference to FIGS. 7 and 8, the connecting crossbeams 11 have a first portion 11a extending parallel to the above-mentioned predetermined plane P and a second portion 11b at a right angle to the first portion 11a and to the predetermined plane P.

Overall, the second orthogonal portions 11b of the crossbeams 11 and the lateral portions 9a, 9b, 10a, 10b of the two pillars 9, 10 define sort of stiffening ribs of the second internal frame 8.

The expression “stiffening rib” means a continuous element projecting relative to the surface parallel to the predetermined plane P, having the purpose of stiffening it to bending and compression, increasing the moment of inertia of the cross-section.

Advantageously, both the lateral pillars 9, 10 and the connecting crossbeams 11 are made of steel and are stably connected to each other by welding to form the second internal frame 8.

Advantageously, as illustrated in FIG. 8, the second orthogonal portion 11b of the crossbeams 11 extends beyond the respective first portion 11a, extending within the overall dimensions of the lateral pillars 9, 10.

In other words, whilst the first portion 11a of each crossbeam 11 extends between the two lateral pillars 9, 10, on the other hand the relative second portion 11b penetrates inside the flat central portion 9c, 10c of each of the pillars 9, 10.

The penetration just described between crossbeams 11 and pillars 9, 10 contributes to increasing the structural rigidity of the second frame 8 and with it, consequently, the strength of the door 1.

As illustrated in FIGS. 5 and 6, the filling layer 7 of expanded material is interposed between the second internal frame 8 and the rigid outer wall 5 of the first outer panel 3. More specifically, advantageously, the filling layer 7 faces the side, of the second internal frame 8, from which extend both the second orthogonal portions 11b of the crossbeams 11 and the lateral portions 9a, 9b, 10a, 10b of the two pillars 9, 10.

As clearly illustrated in FIG. 5, the filling layer 7 made of expanded material has a plurality of grooves 12 designed to house both the orthogonal portions 11b of the crossbeams 11 and the lateral portions 9a, 9b, 10a, 10b of the two pillars 9, 10.

Thanks to the presence of the grooves 12, the overall dimensions of the above-mentioned second orthogonal portions 11b and lateral portions 9a, 9b, 10a, 10b do not affect the overall thickness of the first outer panel 3, thereby allowing the rigidity of the outer panel 3 itself (and of the door 1) to be usefully increased without increasing the overall size.

In other words, the second internal frame 8 is substantially integrated inside the first outer panel 3.

According to alternative embodiments of the door according to the invention, not illustrated, the second internal frame 8 is only partly integrated inside the first outer panel 3.

With reference to FIG. 8, along the connecting edges 9a, 10a of each pillar 9, 10, respective pluralities of holes are made substantially along the entire longitudinal extension of the edge 9a, 10a.

Advantageously, the presence of the above-mentioned holes allows the use of connecting elements, not illustrated, such as screws or rivets for rigidly and stably connecting the second internal frame 8 to the first peripheral frame 2.

The use of connecting elements such as screws or rivets, which are alternatives, therefore, to welding, usefully allows different materials to be used, for the above-mentioned peripheral frame 2 and internal frame 8.

Advantageously, according to the preferred but not exclusive embodiment illustrated in the accompanying drawings, the first peripheral frame 2 is made of aluminium or an aluminium alloy, whilst the second internal frame 8 is made of steel.

The door of recreational vehicles according to the invention achieves the preset aims and brings important advantages.

A first advantage linked to the invention is due to the fact that it provides a door equipped with an inner stiffening frame but having a thickness substantially equal to a normal door without a reinforcing frame.

A second advantage linked to the invention is due to the fact that thanks to the integration of the second frame inside the outer panel of the door, the production steps of the door have also not undergone particular modifications or complications, with the exception of the fact that the screws or the rivets necessary for fixing the second frame inside the first peripheral frame must be applied.

Yet another advantage of the door according to the invention is linked to the shape of the second inner frame with two lateral pillars connected to the peripheral frame for their entire length, which allows the door to be stiffened considerably. In effect, when the door is closed, the first peripheral frame is connected to the structure of the vehicle thanks to robust hinges and locks and the second inner frame creates a sort of structural continuity which passes through the door compartment.

Thanks to this, the door according to the invention is able to withstand even considerable stresses coming both from the inside (for example a load or a passenger pushed against the door during travel) and from the outside (in the case of a road accident with lateral impact).

1. Door of recreational vehicles, comprising:
a first peripheral frame,
a first outer panel shaped according to said first peripheral frame and located inside said first peripheral frame, said first outer panel extending according to a determined plane (P);
a second internal frame which is stably connected to said first peripheral frame; and
a second inner covering panel substantially overlapping said first outer panel.

2. Door of recreational vehicles according to claim 1, wherein said second internal frame is at least partially integrated in said first outer panel.

3. Door of recreational vehicles according to claim 1, wherein said second internal frame comprises two lateral pillars and at least two connecting crossbeams to connect said pillars.

4. The service door according to claim 3, wherein said two lateral pillars are made of sheet metal and have an edge for connection to said first peripheral frame.

5. Door of recreational vehicles according to claim 4, wherein each of said two lateral pillars has a transverse section in the shape of a U, with a flat central portion parallel to said determined plane (P) and two opposite lateral portions, orthogonal to said determined plane (P), one of said lateral portions defining said connecting edge.

6. Door of recreational vehicles according to claim 3, wherein said at least two connecting crossbars are made of metal sheet, and wherein said connecting crossbeams have a first portion extending parallel to said determined plane (P) and a second orthogonal portion orthogonal to said determined plane (P).

7. Door of recreational vehicles according to claim 6, wherein said first outer panel comprises a filling layer of expanded material, and wherein said filling layer of expanded material has respective housing grooves to at least partially house at least said second orthogonal portions of said connecting crossbeams.

8. Door of recreational vehicles according to claim 6, wherein said second orthogonal portion of said connecting crossbeams protrudes beyond the respective first portion, extending within an encumbrance of said lateral pillars.

9. Door of recreational vehicles according to claim 3, wherein said lateral pillars and connecting crossbeams are made of steel and are permanently connected by welding to form said second internal frame.

10. Recreational vehicle comprising a door according to claim 1.
